(19) United States
(12) Patent Application Publication
(10) Pub. No.: US 2006/0266583 A1
(43) Pub. Date: Nov. 30, 2006

(54) SECURITY AND STABILITY BRACKET FOR LADDERS

(76) Inventor: David Jones, Roswell, GA (US)

Correspondence Address: SMITH FROHWEIN TEMPEL GREENLEE BLAHA, LLC, P.O. BOX 88148, ATLANTA, GA, 30356, US

(21) Appl. No.: 10/908,125

(22) Filed: Apr. 28, 2005

(51) Int. Cl. E06C 7/42

(52) U.S. Cl. 182/107; 182/214

(57) ABSTRACT

A bracket for securing a ladder to a surface and thereby fix the ladder at a particular inclination and prevent the ladder from falling away from the surface. The bracket can include one or two bracket elements for securing the ladder by holding the rails of the ladder. The brackets can be constructed such that the method of placing the ladder into the brackets locks the ladder in place or, one or both of the brackets can be adjusted from an open to closed position to lock the ladder into place.

### CROSS-REFERENCE TO RELATED APPLICATIONS

This application claims the benefit of the filing date U.S. Provisional Application for Patent by the same title, having been filed on Apr. 30, 2004 and assigned Ser. No. 60/566,707.

### BACKGROUND OF THE INVENTION

The present invention is directed towards a mechanism for securing and stabilizing ladders and, more specifically, a mechanism to prevent ladders used for accessing roofs of structures or other access from sliding off or falling back, to allow for a safer boarding and un-boarding of the roof, and to fix the ladder at an optimum angle in some embodiments.

Have you ever used a ladder to gain access to the roof of a structure, and while you were working away, have the wind blow the ladder off, leaving you stranded on the roof? You can imagine many situations in which such a happenstance could be greatly inconvenient. Since the advent of the free-standing ladder, users have been plagued with the dangers associated with their use. Free-standing ladders are leaned against walls, building structures or other upright structures. The free-standing ladders are subject to sliding along the surface that they are leaning against, or can pull away from the surface and fall away. Such problems can result in injury to users of the ladder or can result in stranding a user on a structure.

Many people have attempted to address the security of free-standing ladders, however, the devices that have been used to date are either too expensive, too complicated or do not contain the flexibility of the present invention.

Ladder safety has been a significant focus of the Occupational Safety and Health Agency (OSHA) and several sections of the Occupational Safety and Health Standards are specifically directed towards ladder safety. For instance, Standard 1910 Subpart D, section 25 is directed towards portable wood ladders, section 26 is directed towards portable metal ladders and section 27 is directed towards fixed ladders. However, even with the focus of a government agency on the safety of ladders, there still exists a need in the art for a mechanism to reliably and cost effectively secure free-standing ladders.

### BRIEF SUMMARY OF THE INVENTION

The present invention includes various embodiments of a bracket that is used to secure a ladder to a structure in a manner to prevent the ladder from moving laterally, moving away from the structure, and forcing the ladder to a particular angular relationship to the structure.

One aspect of the invention is a bracket that receives a rail of the ladder and forces the rail of the ladder to rest at a particular angle of inclination, and holds the ladder in place to prevent the ladder from falling away from a resting surface. Another aspect of the invention includes the use of two brackets to receive each of the rails of the ladder and hold the ladder in place. Another aspect of the present invention is the use of an adjustable second bracket that can be moved laterally in relationship to the first bracket between an open or closed position. Thus, a ladder can be inserted while the second bracket is resting in an open position but, once the second bracket is moved to the closed position, the ladder is held securely.

Brackets embodying one or more aspects of the present invention can be secured to surfaces such as a roof, a wall, an eve, a pole, etc. to improve the safety and stability of the ladder while in use. Advantageously, the present invention can be installed on a variety of structures and used by any parties requiring access to the structure.

### BRIEF DESCRIPTION OF THE SEVERAL VIEWS OF THE DRAWING

FIG. 1 is a side view of a ladder being secured and stabilized by an embodiment of the present invention.

FIG. 2 is a diagram illustrating top view and side view of an embodiment of the bracket device that uses a stationary clamp.

FIG. 3 is a diagram illustrating top view and side view of an embodiment of the present invention utilizing two stationary brackets and a “U” shaped slidable bracket.

FIG. 4 is a diagram illustrating an embodiment of the present invention that includes a fixed portion and a slideable portion.

FIG. 5 is a diagram illustrating an embodiment of the bracket device that includes a motorized actuator.

FIG. 6 is a diagram illustrating an embodiment of the bracket device utilizing two stationary brackets and a tie-down mechanism.

FIG. 7 is a diagram illustrating an embodiment of the present invention utilizing fixed brackets with flanges.

### DETAILED DESCRIPTION OF THE INVENTION

The present invention is directed towards a bracket that is used to securely and safely hold a ladder against a structure. One of the benefits of the present invention includes securing the ladder to a building for roof access in a manner to prevent the ladder from sliding laterally. Another benefit includes securing the ladder to a building in a manner to prevent the ladder from falling back away from the building. Another benefit includes forcing the ladder to a particular inclination that is suitable for climbing.

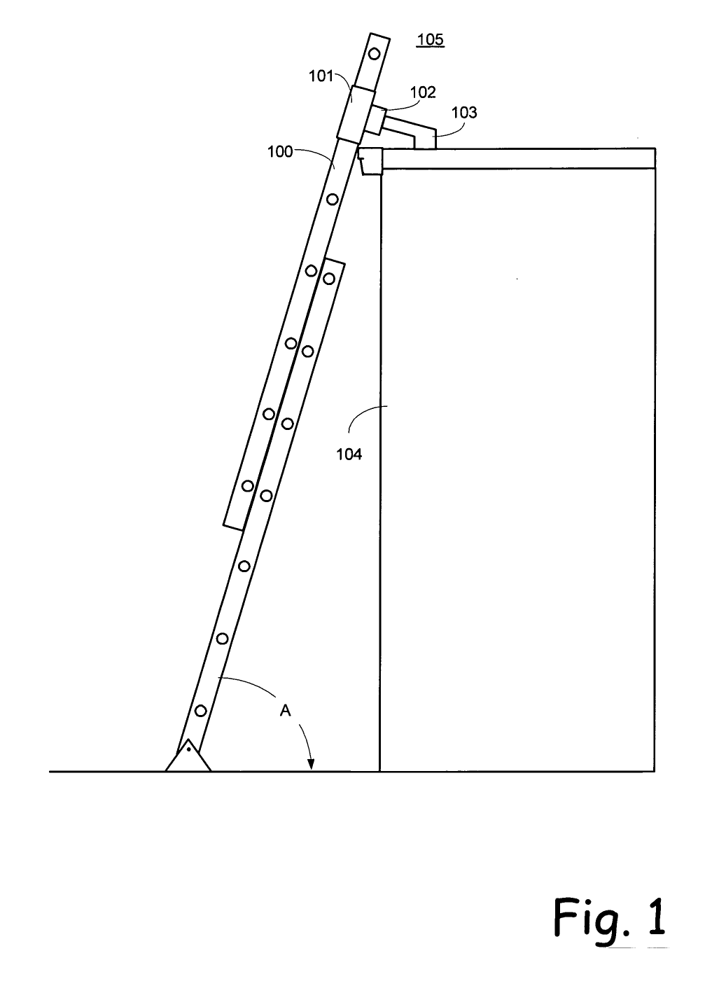

FIG. 1 is a side view of a ladder being secured and stabilized by an embodiment of the present invention. The ladder 100 is shown as being used to access the roof of structure 104. However, it should be appreciated that the present invention can be used for accessing not only roofs, but also traversing polls or in any other application in which a ladder is used for access. One end of the ladder 100 is placed into the clamp or holding device 101 of the bracket device 105. The clamp 101 is a shown as being attached to mounting platform 102. Mounting platform 102 is attached to mounting brace 103. The mounting brace 103 then attaches to the structure 104. Together, the clamp 101, the mounting platform 102 and the mounting brace 103 form the bracket device 105. It should be understood that the clamp 101, mounting platform 102 and mounting brace 103 can be integrally formed as the bracket device 105 as a singular unit or can be joined together with bolts, welding beads or other permanent or semi-permanent means. The ladder 100 is securely held in place by the bracket 105. In addition, in this particular embodiment, the incline A of the ladder 100 is being dictated by the bracket device 105. It should be appreciated that the angle of A can vary greatly depending on the particular application and the circumstances and terrain in which the ladder is being used. In some embodiments the angle A can be greater than or less than 90 degrees.

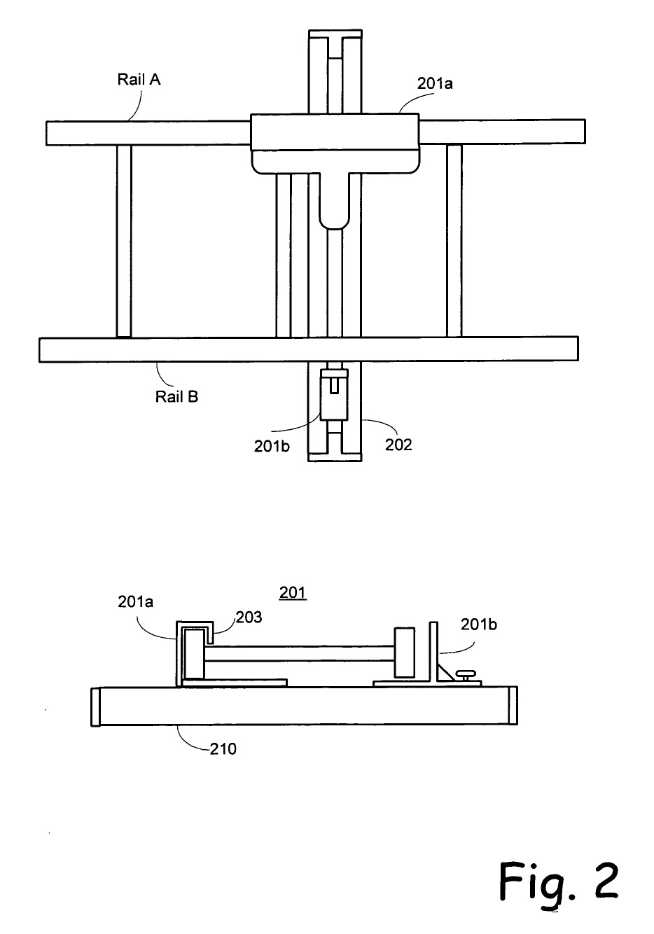

FIGS. 2-7 show various embodiments of the bracket device 105. In the illustrated embodiments, various configurations of the clamp 101 and mounting platform 102 are shown. In some embodiments, a groove in the mounting platform 102 allows for the clamp 101 to be placed in the optimum position for each application. Another benefit of the present invention but not necessarily required is that the mounting platform 102 can be constructed wide enough to serve as a step when returning to the ladder from the structure. This greatly improves the safety in mounting and dismounting the ladder. The various embodiments are described in greater detail along with the descriptions of FIGS. 2-7 but it should be appreciated that the illustrated embodiments are only exemplary uses or implementations of the present invention and not all aspects of the present invention are required in the various embodiments and the various embodiments to not fully disclose all possible embodiments of the present invention.

FIG. 2 is a diagram illustrating an embodiment of the bracket device that uses a stationary clamp. In this embodiment, the clamp 201 includes a first clamp portion 201a for receiving rail A and a second clamp portion 201b for receiving rail B. In the illustrated embodiment, clamp portions 201a and 201b are stationary and have no moving parts. The ladder 100 is placed between the clamp portions 201a and 201b with the ladder rails being parallel with a surface 210 of the clamp 201. To secure the ladder, the ladder is rolled counter clockwise by lifting rail B from the surface of the mounting platform 202 and sliding rail A under a retaining lip 203 of clamp portion 201a. Rail B can then be returned to resting on the mounting platform 202 and the ladder is secured and ready for use. The retaining lip 203 prevents the ladder 100 from falling away from the structure or from sliding traverse to the structure.

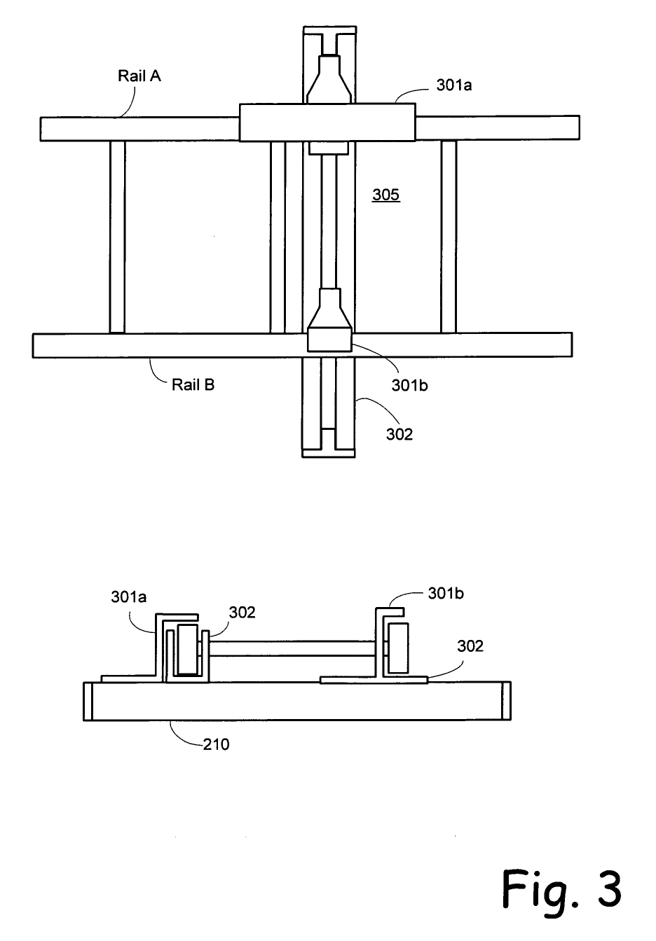

FIG. 3 is a diagram illustrating an embodiment of the bracket device 105 utilizing two stationary brackets and a “U” shaped slidable bracket. Two stationary brackets 301a and 301b are mounted to the mounting platform 302. The “U” shaped bracket 303 slides laterally between two positions, an open position and a closed position. In the open position, the bracket device 305 is able to receive a ladder. In the closed position, the ladder is held in place securely. FIG. 3 illustrates the closed position. In each of these two positions, the “U” shaped bracket 303 can be held in place by various means, such as magnetism, latches, springs or the like. To secure a ladder into the bracket device 305, the user places the ladder into this device by inserting rail A into the “U” shaped bracket 303 while it rests in the open position. Rail B will rest against the platform 302 a distance from bracket 301b. The user then slides the ladder laterally with enough force to move the “U” shaped bracket 303 from its open position, to the closed position—positioned under bracket 301a. Once the U shaped bracket 303 is under the bracket 301a, the ladder rail A is held securely in place. In addition, ladder rail B is moved under bracket 301b where it is restricted from lifting away from the bracket device 105. To further secure the “U” shaped bracket 303 in the two positions, the “U” shaped bracket can be held in place by magnetic force. Other mechanisms may also be used to secure the “U” shaped bracket 303 into the two positions and the present invention is not limited to any particular method and does not require the use of any such mechanism. In fact, the “U” shaped bracket 303 may be freely slideable between the two positions or simply held in place by friction.

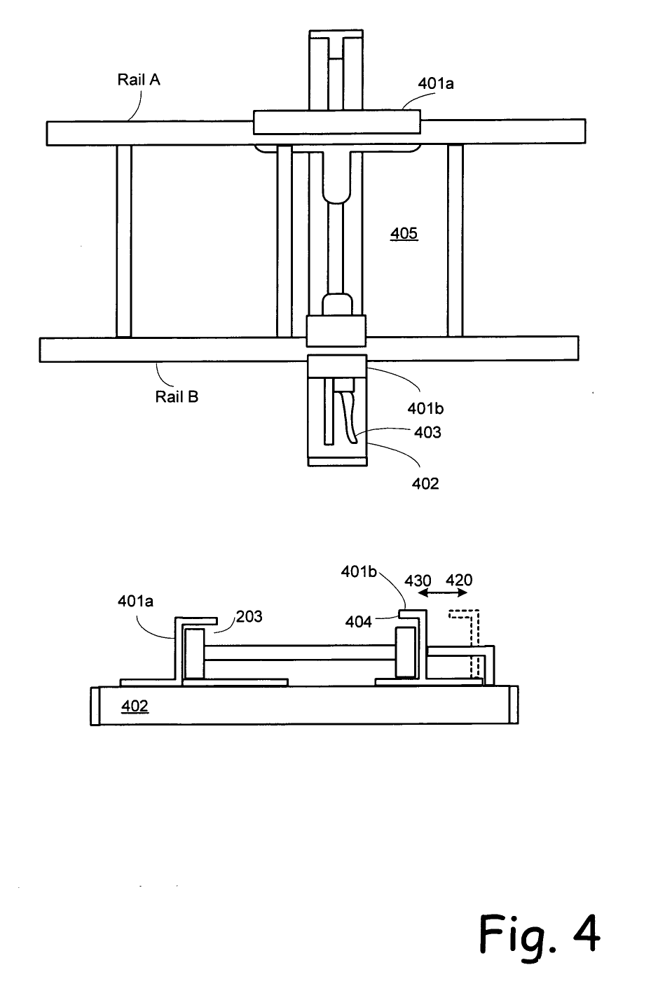

FIG. 4 is a diagram illustrating an embodiment of the bracket device that includes a fixed portion and a slideable portion. The bracket 405 dictates the inclination of the ladder and restricts movement of the ladder either laterally or away from the device or surface upon which it rests. The ladder is held in place by bracket having a fixed bracket portion 401a and a slideable bracket portion 401b. Bracket portion 401b can slide horizontally between an open position 420 and a closed position 430. To secure a ladder, the user places the ladder into the device between brackets 401a and 401b. The user then slides the ladder laterally until rail A is under bracket 401a, adjusting the incline of the ladder if necessary to get the rail A to fit under the flange of bracket 401. The user can then climb the ladder and actuate a hand-lever 403 which allows bracket 401b to be moved from the open position to the closed position. In the closed position, the flange of bracket 401b is positioned over rail B of the ladder. The hand-lever could take on a variety of embodiments including a ratchet like actuator, typical to what is found on a caulk gun, to clamp the bracket against the ladder. In another embodiment, the hand-lever could simply toggle on and off a securing mechanism. Thus, when the securing mechanism is on, the bracket 401b cannot be moved. This aspect of the present invention is advantageous in that any width ladder can be used with the bracket device 405.

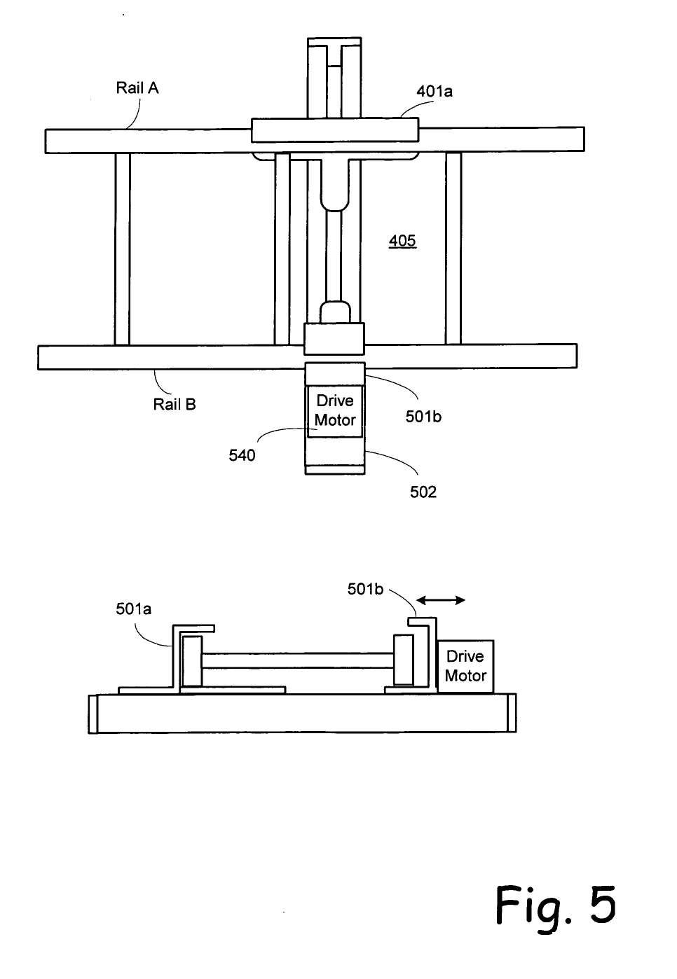

FIG. 5 is a diagram illustrating an embodiment of the bracket device that includes a motorized actuator. A drive motor 540 can be used to adjust the slideable or adjustable portions on any embodiment of the present invention but is shown in FIG. 5 in conjunction with the embodiment of FIG. 4. In this embodiment, bracket 505 can be adjusted between an open and closed position by moving adjustable bracket portion 501b away or towards fixed bracket portion 501a. When closed, a ladder is unable to move laterally, or away from the bracket device 505. The adjustable bracket 501b is moved between the open and closed position by actuator 540. Actuator 540 is typically a drive motor that uses a linkage such as a worm gear used on a typical garage door opener. A torque-limiter switch can be used to stop the motor when bracket 501b is securely clamped to the ladder. To secure a ladder, the user would place the ladder into the device between brackets 501a and 501b. The incline of the ladder is adjusted to allow rail A of the ladder to slide under the flange of bracket 501a. The user can then actuate a switch that will cause the motor 540 to move the bracket 501b and secure the ladder. The switch could be a wall mounted switch, a remote control device that wirelessly communicates with the motor, a ladder mounted switch that completes a circuit when the ladder is placed in to the bracket, either automatically or as a result of actuating a switch. In the automatic configuration, once the ladder is placed into the bracket, the motor automatically begins moving the bracket 501b towards the ladder to secure the ladder in place. The motor 540 can also include a release button, that when actuated will pull the bracket 501b away from the ladder, thereby allowing the ladder to be removed. In one embodiment, the motor 540 can include a delayed reset button. The user can actuate the reset button prior to descending the secured ladder. After a period of time, the motor 540 will reset and pull the bracket 501b away from the ladder. The timing of the reset should be set to a length long enough to allow a user to descend the ladder at a safe pace.

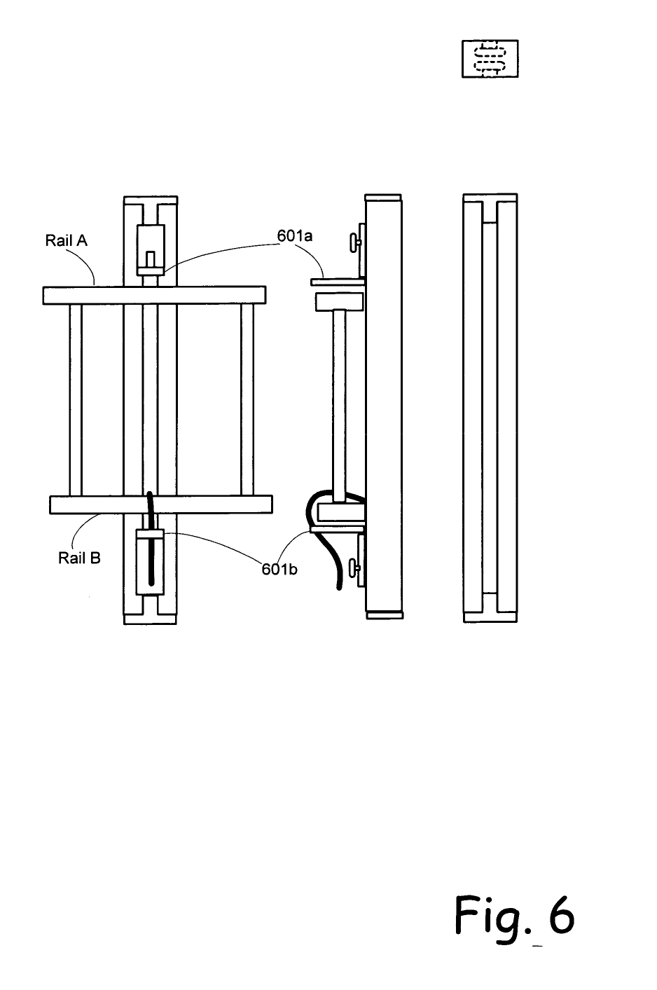

FIG. 6 is a diagram illustrating an embodiment of the bracket device utilizing two stationary brackets and a tie-down mechanism. In this embodiment of the present invention, two stationary “L” brackets 601a and 601b are used to support the ladder and prevent lateral movement of the ladder. The rails of the ladder are placed between the “L” shaped brackets. The user can then ascend the ladder and further secure the ladder using a rope or a clamping means 620 attached to one or both of the “L” shaped brackets. In the illustrated embodiment, a rope 620 is used to secure rail B of the ladder to bracket portion 601b.

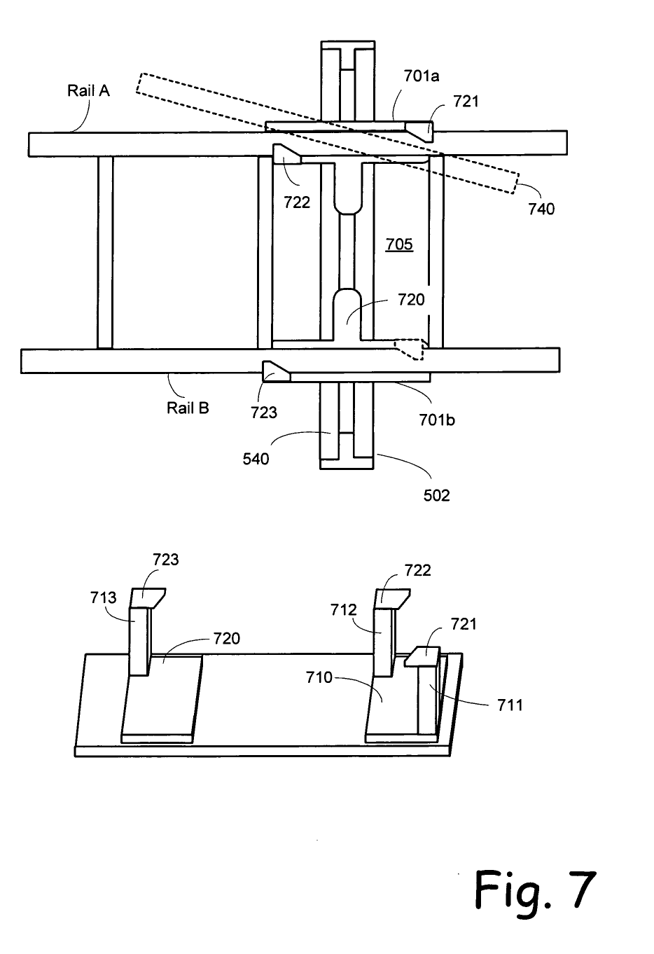

FIG. 7 is a diagram illustrating an embodiment of the present invention utilizing fixed brackets with flanges. In this embodiment of the present invention, bracket 705 includes at least one bracket element and can include two. The first bracket element 701a includes a support surface 710 on which the rail, rail A, of the ladder rests. The support surface 710 includes a first post 711 and a second post 712 that extend perpendicular to the support surface 710 and are positioned on opposite corners of the support surface 710. On top of each of the first post 711 and the second post 712 is a flange or dog ear 721 and 722 respectively, that extends substantially parallel to the support surface 710. Bracket 701b is very similar to bracket 701a with the exception that it only includes one post 713 extending from a surface 720 and one flange 723. Bracket 701b may include some lateral movement to adjust for ladders of different widths and can be held in the left most position with spring tension until forced outward by rail B of the ladder. All three posts in this diagram are preferably “dog eared” at the top to restrict movement and dictate angle of use.

To secure a ladder using this embodiment of the present invention, the user tips the ladder laterally as shown by phantom 740, or angles the rail of the ladder at a first angle until rail A passes between flanges or protrusions 721 and 722. The angle of the rail is then adjusted to a second angle to allow it to pass under both “dog ears” as it is brought back to vertical. This operates to hold the ladder in place. At the same time, rail B comes into contact with item 723 and pushes bracket 701b right to accommodate the width of the ladder.

The present invention brings great advancement in the art. Various embodiments of the present invention can be adapted to provide the safety and security of the invention in several situations. For instance, the present invention can be used to grant access to the roof of a structure by mounting an embodiment of the present invention on the wall or roof of the structure. The present invention can be used to establish the angle of the ladder at the optimal 75 degree angle but, can also be used to establish other preferred angles depending on the particular requirements. In fact, the present invention can be used to set the ladder at a greater than 90 angle from the surface if necessary. For instance, if the wall of a structure is tapered outwardly, the present invention can be used to sure the ladder in the angle of the walls taper and thus granting access to the tapered wall. The present invention can also be used to attach a ladder to a totally vertical structure such as a poll. If there is little to no room to allow the base of the ladder to be positioned away from the structure, the present invention allows for the ladder to be secured at an angle with the base of the ladder closer to the structure.

Various aspects, advantages and embodiments of the present invention have been described. It should be appreciated that the present invention can be included in a variety of embodiments that incorporate all or only some of the inventive aspects of the present invention. Although particular elements may have been described as non-limiting to the present invention, such a statement does not imply that the element in and of itself is not novel or non-obvious.

What is claimed is:

1. An apparatus for securing a ladder, the apparatus comprising:
a first bracket element that is operative to receive a rail of a ladder;
a base for mounting the bracket element to a surface;
a support plane integral to the apparatus and upon which the rail of the ladder can rest and thereby being operative to force the ladder to a desired angle of inclination; and
a securing means for maintaining the ladder within the first bracket element.

2. The apparatus of claim 1, wherein the securing means of the first bracket element includes a flange that extends laterally from the bracket element substantially parallel to the support plane and creates a space in which the rail of the ladder can rest and prevents the ladder from raising from the support plane.

3. The apparatus of claim 1, further comprising a second bracket element positioned such that each rail of a ladder can be placed proximate to one of either the first or second bracket elements.

4. The apparatus of claim 3, wherein the second bracket element is adjustable between an open and closed position.

5. The apparatus of claim 4, wherein when the rails of the ladder are placed proximate to the first and second bracket element and the second bracket element is moved to the closed position, the ladder becomes fixed at a desired angle and is secured in position.

6. The apparatus of claim 4, wherein a drive motor is used to adjust the second bracket element between the open and closed position.

7. The apparatus of claim 4, wherein a spring is used to encourage the second bracket element to remain in the closed position.

8. The apparatus of claim 1, wherein the first bracket element includes a first post and a second post, the first post and second post extending substantially parallel to each other and substantially perpendicular to the support plane and existing on opposite corners of the support plane, each of the first and second post including a first and second flange mounted respectively to the end of the first and second posts distal to the support plane and substantially parallel to the support plane, the first and second flanges extended towards the center of the support plane and having the characteristic that a ladder rail can be inserted between the first and second posts at a first angle, and then when adjusted to a second angle, the first and second flanges hold the rail securely.

9. The apparatus of claim 8, further comprising a second bracket element that includes a third post extending substantially perpendicular from a corner of the support plane and includes a third flange mounted to the end of the third posts distal to the support plane and substantially parallel to the support plane and operative to receive the opposite rail of the ladder.

10. An apparatus that can be mounted to a resting surface for the purpose of securing a ladder to the resting surface while in operation, the apparatus comprising:
a first bracket element that is operative to receive a first rail of a ladder;
a second bracket element that is operative to receive a second rail of a ladder;
a support surface to which the first and second bracket elements are coupled and that can be attached to the resting surface; and
a securing means for maintaining the ladder within the first and second bracket elements.

11. The apparatus of claim 10, wherein the securing means is a flange on the first bracket that extends over the first rail of the ladder.

12. The apparatus of claim 10, wherein the second bracket element is adjustable to accommodate ladders of varying widths.

13. The apparatus of claim 10, wherein the second bracket element is adjustable between a first and second position.

14. The apparatus of claim 13, wherein the ladder is inserted into the apparatus while the second bracket element is in a first position, and the ladder is secured when the second bracket element is adjusted towards the first bracket element to the second position.

15. The apparatus of claim 14, wherein the second bracket element is adjusted by a drive motor.

16. The apparatus of claim 10, wherein the support surface is substantially parallel to the resting surface and establishes the angle of inclination for the ladder.

17. The apparatus of claim 10, wherein the first bracket element includes a first post and a second post, the first post and second post extending substantially parallel to each other and substantially perpendicular to the support plane and existing on opposite corners of the support plane, each of the first and second post including a first and second protrusion extending respectively from the end of the first and second posts distal to the support plane and substantially parallel to the support plane, the first and second protusions extended towards the center of the support plane and having the characteristic that a ladder rail can be inserted between the first and second posts at a first angle, and when the ladder is adjusted to a second angle, the first and second protrusions hold the rail securely.

18. The apparatus of claim 17, wherein the second bracket element includes a third post extending substantially perpendicular from a corner of the support plane and includes a third protusion mounted to the end of the third posts distal to the support plane and substantially parallel to the support plane and operative to receive the opposite rail of the ladder.

19. The apparatus of claim 18, wherein the second bracket element is adjustable between a first and second position.

20. The apparatus of claim 19, wherein the ladder is inserted into the apparatus while the second bracket element is in a first position, and the ladder is secured when the second bracket element is adjusted towards the first bracket element to the second position.
